(19) United States
(12) Patent Application Publication
(10) Pub. No.: US 2003/0119696 A1
(43) Pub. Date: Jun. 26, 2003

(54) Pouched Composition

(75) Inventors: Barry Thomas Ingram, Tyne ?amp; Wear (GB); Bruno Matthieu Dasque, Newcastle-Upon-Tyne (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/278,642

(22) Filed: Oct. 23, 2002

Related U.S. Application Data
(63) Continuation of application No. PCT/US01/07778, filed on Mar. 9, 2001.

(30) Foreign Application Priority Data
Apr. 28, 2000 (GB) 0010250.9

(51) Int. Cl. C11D 17/00

(52) U.S. Cl. 510/296; 510/297; 510/439

(57) ABSTRACT

The present invention relates to pouched compositions which comprise an alkoxylated compound. Preferably the alkoxylated compound has an average alkoxylation degree of at least 50, preferably at least 80.

### CROSS REFERENCE TO RELATED APPLICATIONS

This is a continuation of International Application PCT/US01/07778 with an international filing date of Mar. 9, 2001, published in English under PCT Article 21(2) which claims benefit of Great Britain Application No. 0010250.9, filed Apr. 28, 2000.

### FIELD OF INVENTION

This invention relates to pouched compositions which comprise an alkoxylated compound.

### BACKGROUND TO INVENTION

The laundry industry has been trying to develop ways that minimise the contact between consumer and detergent product. Such contact includes; contacting the detergent ingredients to the skin of the consumer which can cause irritation to the contacted area, for example causing rashes, blotches, itchiness; and also contacting detergent ingredients in the form of dust, which can become airborne when the product is dosed, to the eyes, nose and even respiratory system of the consumer, causing discomfort to said affected areas.

Another method of minimising the contact between detergent and consumer is to enclose the detergent with a pouch, such as pouches made from a water-soluble film, to form a water-soluble detergent pouch.

The inventors have found that detergents in water-soluble pouches show poor clay stain removal during the washing cycle. Furthermore, the inventors have found that this poor clay stain removal is due to the water-soluble film. It is believed that the water-soluble film cross-links clay present in the wash liquor in such a manner as to redeposit the clay onto the surface of the fabric. This is thought to be especially true when the water-soluble film comprises a hydroxy group, or particularly more than one hydroxy group, such as water-soluble films comprising polyvinyl alcohol. It is believed that the hydroxyl groups are attracted to the surface of certain clays.

Moreover, the inventors have found that the addition of specific alkoxylated compounds having an alkoxylation degree of at least 50 to the detergent composition comprised by a water-soluble film solves the problem of poor clay stain removal by detergents in such pouches. Thus, the addition of certain alkoxylated compounds having an alkoxylation degree of at least 50 to a detergent composition comprised by a water-soluble film having a hydroxy group, such as films which comprise a polyvinyl alcohol polymer, improves the clay removal performance of said detergent composition.

### SUMMARY OF INVENTION

In a first embodiment of the invention a composition is provided which comprises an alkoxylated compound having an alkoxylation degree of at least 50, wherein the composition is enclosed by a pouch made from a water-soluble film.

In a second embodiment of the invention a process for preparing a composition comprising an alkoxylated compound having an alkoxylation degree of at least 50 and wherein the composition is enclosed by a pouch made from a water-soluble film is provided which comprises the steps;

(a) contacting a composition comprising an alkoxylated compound having an average alkoxylation degree of at least 50 to a water-soluble film in such a way as to partially enclose said composition by said water-soluble film to obtain a partially formed pouch; and

(b) optionally contacting said partially formed pouch with a second water-soluble film; and

(c) sealing said partially formed pouch to obtain a pouch.

In a third embodiment of the invention the use of an alkoxylated compound having an average alkoxylation degree of at least 50, preferably at least 80 is provided to improve the cleaning performance of a detergent composition in wash water comprising water-soluble film material, in particular polyvinyl alcohol.

### DETAILED DESCRIPTION OF INVENTION

Pouch and Material Thereof

The pouch of the invention, herein referred to as “pouch”, is typically a closed structure, made of a water-soluble film described herein, enclosing a volume space which comprises a composition. Said composition is described in more detail herein. The pouch can be of any form, shape and material which is suitable to hold the composition, e.g. without allowing the release of the composition from the pouch prior to contact of the pouch to water. The exact execution will depend on for example, the type and amount of the composition in the pouch, the number of compartments in the pouch, the characteristics required from the pouch to hold, protect and deliver or release the compositions.

The pouch may be of such a size that it conveniently contains either a unit dose amount of the composition herein, suitable for the required operation, for example one wash, or only a partial dose, to allow the consumer greater flexibility to vary the amount used, for example depending on the size and/or degree of soiling of the wash load.

It may be preferred that the water soluble film and preferably the pouch as a whole is stretched during formation and/or closing of the pouch, such that the resulting pouch is at least partially stretched. This is to reduce the amount of film required to enclose the volume space of the pouch. When the film is stretched the film thickness decreases. The degree of stretching indicates the amount of stretching of the film by the reduction in the thickness of the film. For example, if by stretching the film, the thickness of the film is exactly halved then the stretch degree of the stretched film is 100%. Also, if the film is stretched so that the film thickness of the stretched film is exactly a quarter of the thickness of the unstretched film then the stretch degree is exactly 200%. Typically and preferably, the thickness and hence the degree of stretching is non-uniform over the pouch, due to the formation and closing process. For example, when a water-soluble film is positioned in a mould and an open compartment is formed by vacuum forming (and then filled with the components of a composition and then closed), the part of the film in the bottom of the mould, furthest removed from the points of closing will be stretched more than in the top part. Preferably, the film which is furthest away from the opening, e.g. the film in the bottom of the mould, will be stretched more and be thinner than the film closest by the opening, e.g. at the top part of the mould.

Another advantage of using stretching the pouch, is that the stretching action, when forming the shape of the pouch and/or when closing the pouch, stretches the pouch non-uniformly, which results in a pouch which has a non-uniform thickness. This allows control of the dissolution of water-soluble pouches herein, and for example sequential release of the components of the detergent composition enclosed by the pouch to the water.

Preferably, the pouch is stretched such that the thickness variation in the pouch formed of the stretched water-soluble film is from 10 to 1000%, preferably 20% to 600%, or even 40% to 500% or even 60% to 400%. This can be measured by any method, for example by use of an appropriate micrometer. Preferably the pouch is made from a water-soluble film that is stretched, said film has a stretch degree of from 40% to 500%, preferably from 40% to 200%.

The pouch is made from a water-soluble film. It is preferred that the pouch as a whole comprises material which is water-dispersible or more preferably water-soluble. Preferred water-soluble films are polymeric materials, preferably polymers which are formed into a film or sheet. The material in the form of a film can for example be obtained by casting, blow-moulding, extrusion or blow extrusion of the polymer material, as known in the art.

Preferred water-dispersible material herein has a dispersability of at least 50%, preferably at least 75% or even at least 95%, as measured by the method set out hereinafter using a glass-filter with a maximum pore size of 50 microns.

More preferably the material is water-soluble and has a solubility of at least 50%, preferably at least 75% or even at least 95%, as measured by the method set out hereinafter using a glass-filter with a maximum pore size of 50 microns, namely:

Gravimetric method for determining water-solubility or water-dispersability of the material of the compartment and/or pouch:

10 grams±0.1 gram of material is added in a 400 ml beaker, whereof the weight has been determined, and 245 ml±1 ml of distilled water is added. This is stirred vigorously on magnetic stirrer set at 600 rpm, for 30 minutes. Then, the mixture is filtered through a folded qualitative sintered-glass filter with the pore sizes as defined above (max. 50 micron). The water is dried off from the collected filtrate by any conventional method, and the weight of the remaining polymer is determined (which is the dissolved or dispersed fraction). Then, the % solubility or dispersability can be calculated.

Preferred polymer copolymers or derivatives thereof are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, most preferably polyvinyl alcohols, polyvinyl alcohol copolymers and hydroxypropyl methyl cellulose (HPMC). Preferably, the level of a type polymer (e.g., commercial mixture) in the film material, for example PVA polymer, is at least 60% by weight of the film.

The polymer can have any weight average molecular weight, preferably from about 1000 to 1,000,000, or even form 10,000 to 300,000 or even form 15,000 to 200,000 or even form 20,000 to 150,000.

Mixtures of polymers can also be used. This may in particular be beneficial to control the mechanical and/or dissolution properties of the compartment or pouch, depending on the application thereof and the required needs. For example, it may be preferred that a mixture of polymers is present in the material of the compartment, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000-40,000, preferably around 20,000, and of PVA or copolymer thereof, with a weight average molecular weight of about 100,000 to 300,000, preferably around 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble.

It may be preferred that the polymer present in the film is from 60-98% hydrolysed, preferably 80% to 90%, to improve the dissolution of the material.

Most preferred are films which are water-soluble and stretchable films, as described above. Highly preferred water-soluble films are films which comprise PVA polymers and that have similar properties to the film known under the trade reference M8630, as sold by Chris-Craft Industrial Products of Gary, Ind., US.

The water-soluble film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful that the pouch or water-soluble film itself comprises a detergent additive to be delivered to the wash water, for example organic polymeric soil release agents, dispersants, dye transfer inhibitors.

The pouch is made by a process comprising the steps of contacting a composition herein to a water-soluble film in such a way as to partially enclose said composition to obtain a partially formed pouch, optionally contacting said partially formed pouch with a second water-soluble film, and then sealing said partially formed pouch to obtain a pouch.

Preferably, the pouch is made using a mould, preferably the mould has round inner side walls and a round inner bottom wall. A water soluble film may be vacuum pulled into the mould so that said film is flush with the inner walls of the mould. A composition herein may then be poured into the mould, a second water-soluble film may be placed over the mould with the composition and the pouch may then be sealed, preferably the partially formed pouch is heat sealed. The film is preferably stretched during the formation of the pouch.

Alkoxylated Compound

The composition comprises an alkoxylated compound, said alkoxylated compound has an average alkoxylation degree of at least 50, more preferably at least 60, more preferably at least 70, more preferably at least 80, more preferably at least 90, more preferably at least 100. Preferably the alkoxy groups are present in one long chain.

Preferably, the alkoxylated compound comprises a hydrocarbon group comprising from 6 to 24, preferably from 8 to 22, more preferably from 10 to 20, more preferably from 12 to 18 carbon atoms, preferably comprising a hydrocarbon chain of an average chain length of from 6 to 24, preferably from 8 to 22, more preferably from 10 to 20, more preferably from 12 to 18 carbon atoms. The hydrocarbon chain may be linear or branched and includes all derivative forms attainable by 6 to 24 carbon atoms in any conformation. These carbon atoms do not include the carbon atoms of the alkoxy groups.

The alkoxylated compound is preferably a nonionic compound. Preferably, the alkoxylated compound is an alcohol, an ester, a ketone, an aldehyde, an amide or a combination thereof. More preferably, the alkoxylated compound is an alcohol. Preferably, the alkoxylated compound is an ethoxylated compound. More preferably the alkoxylated compound is an ethoxylated alcohol. Most preferably, the alkoxylated compound is a tallow alcohol ethylene oxide condensate, condensed with at least 50, more preferably at least 60, more preferably at least 70, more preferably at least 80, more preferably at least 90, more preferably at least 100 moles of ethylene oxide.

Said alkoxylated alcohol can be added to the other ingredients to form the composition of the invention by any process known in the art, such as agglomeration or dry mixing. Preferably the composition herein (described in more detail hereinafter) comprises (by weight of the composition) from 0.001% to 25%, more preferably from 0.1% to 10%, more preferably form 0.5% to 5%, more preferably from 1% to 3% said alkoxylated compound. The composition herein may comprise alkoxylated compounds having an alkoxylation degree of less than 50 in addition to the alkoxylated compound of the invention.

The alkoxylated alcohol of the present invention can be used in a composition enclosed by a water-soluble film, said water-soluble film preferably comprises polyvinyl alcohol, to improve the clay removing performance of said composition.

Pouched Composition

The pouch comprises a composition, typically said composition is contained in the inner volume space of the pouch.

The compositions herein are cleaning compositions or fabric care compositions, preferably hard surface cleaners, more preferably laundry or dish washing compositions, including pre-treatment or soaking compositions and rinse additive compositions.

Typically, the composition comprises such an amount of a cleaning composition, that one or a multitude of the pouched compositions is or are sufficient for one wash.

The composition can contain any active cleaning ingredient. In particular preferred are active ingredients such as chelating agents, builders, enzymes, perfumes, bleaches, bleach activators, fabric softeners, fabric conditioners, surfactants, other fabric conditioners, antibacterial agents, effervescence sources, brighteners, photo-bleaches. Fabric care compositions preferably comprise at least one or more softening agents, such as quaternary ammonium compounds and/or softening clays, and preferably additional agent such as anti-wrinkling aids, perfumes and chelating agents.

Preferably the composition comprises a chelating agent. It is also preferred that the composition is free from borate. Preferably, the composition comprises at least one surfactant and at least one building agent.

It may be possible that part or all of the components of the composition are not pre-granulated, such as agglomerated, spray-dried, extruded, prior to incorporation into the compartment, and that the composition is a mixture of dry-mixed powder ingredients or even raw materials. Preferred may be that for example less than 60% or even less than 40% or even less than 20% of the component is a free-flowable pre-granulated granules.

Preferred Ingredients of the Composition

The preferred amounts of ingredients described herein are % by weight of the composition herein as a whole.

Chelating Agents

The composition herein, preferably comprises a chelating agent. By chelating agent it is meant herein components which act to sequester (chelate) heavy metal ions. These components may also have calcium and magnesium chelation capacity, but preferentially they show selectivity to binding heavy metal ions such as iron, manganese and copper.

Chelating agents are generally present at a level of from 0.05% to 2%, preferably from 0.1% to 1.5%, more preferably from 0.25% to 1.2% and most preferably from 0.5% to 1% by weight of the composition herein.

Suitable chelating agents for use herein include organic phosphonates, such as the amino alkylene poly (alkylene phosphonates), alkali metal ethane 1-hydroxy bisphosphonates and nitrilo trimethylene phosphonates.

Preferred among the above species are diethylene triamine penta (methylene phosphonate), ethylene diamine tri (methylene phosphonate) hexamethylene diamine tetra (methylene phosphonate) and hydroxy-ethylene 1,1 diphosphonate.

Other suitable chelating agents for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof. Especially preferred is ethylenediamine-N,N′-disuccinic acid (EDDS) or the alkali metal, alkaline earth metal, ammonium, or substituted ammonium salts thereof, or mixtures thereof.

Other suitable chelating agents for use herein are iminodiacetic acid derivatives such as 2-hydroxyethyl diacetic acid or glyceryl imino diacetic acid, described in EP-A-317,542 and EP-A-399,133. The iminodiacetic acid-N-2-hydroxypropyl sulfonic acid and aspartic acid N-carboxymethyl N-2-hydroxypropyl-3-sulfonic acid sequestrants described in EP-A-516,102 are also suitable herein. The β-alanine-N,N′-diacetic acid, aspartic acid-N,N′-diacetic acid, aspartic acid-N-monoacetic acid and iminodisuccinic acid sequestrants described in EP-A-509,382 are also suitable.

EP-A-476,257 describes suitable amino based sequestrants. EP-A-510,331 describes suitable sequestrants derived from collagen, keratin or casein. EP-A-528,859 describes a suitable alkyl iminodiacetic acid sequestrant. Dipicolinic acid and 2-phosphonobutane-1,2,4-tricarboxylic acid are also suitable. Glycinamide-N,N′-disuccinic acid (GADS), ethylenediamine-N-N′-diglutaric acid (EDDG) and 2-hydroxypropylenediamine-N-N′-disuccinic acid (HPDDS) are also suitable.

Detersive Surfactants

Nonionic Alkoxylated Surfactant

Essentially any alkoxylated nonionic surfactants can be comprised by the composition herein. These nonionic surfactants are in addition to the alkoxylated compound of the invention. The ethoxylated and propoxylated nonionic surfactants are preferred. Preferred alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

Highly preferred are nonionic alkoxylated alcohol surfactants, being the condensation products of aliphatic alcohols with from 1 to 75 moles of alkylene oxide, in particular about 50 or from 1 to 15 moles, preferably to 11 moles, particularly ethylene oxide and/or propylene oxide, are highly preferred nonionic surfactants. The alkyl chain of the aliphatic alcohol can either be straight or branched, primary or secondary, and generally contains from 6 to 22 carbon atoms. Particularly preferred are the condensation products of alcohols having an alkyl group containing from 8 to 20 carbon atoms with from 2 to 9 moles and in particular 3 or 5 moles, of ethylene oxide per mole of alcohol.

Nonionic polyhydroxy fatty acid amide surfactant

Polyhydroxy fatty acid amides are highly preferred nonionic surfactant comprised by the composition, in particular those having the structural formula R²CONR¹Z wherein: R¹ is H, C₁₋₁₈, preferably C₁-C₄ hydrocarbyl, 2-hydroxy ethyl, 2-hydroxy propyl, ethoxy, propoxy, or a mixture thereof, preferable C1-C4 alkyl, more preferably C₁ or C₂ alkyl, most preferably C₁ alkyl (i.e., methyl); and R₂ is a C₅-C₃₁ hydrocarbyl, preferably straight-chain C₅-C₁₉ or C₇-C₁₉ alkyl or alkenyl, more preferably straight-chain C₉-C₁₇ alkyl or alkenyl, most preferably straight-chain C₁₁-C₁₇ alkyl or alkenyl, or mixture thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar in a reductive amination reaction; more preferably Z is a glycityl.

A highly preferred nonionic polyhydroxy fatty acid amide surfactant for use herein is a C₁₂-C₁₄, a C₁₅-C₁₇ and/or C₁₆-C₁₈ alkyl N-methyl glucamide.

It may be particularly preferred that the composition herein comprises a mixture of a C₁₂-C₁₈ alkyl N-methyl glucamide and condensation products of an alcohol having an alkyl group containing from 8 to 20 carbon atoms with from 2 to 9 moles and in particular 3 or 5 moles, of ethylene oxide per mole of alcohol.

The polyhydroxy fatty acid amide can be prepared by any suitable process. One particularly preferred process is described in detail in WO 9206984. A product comprising about 95% by weight polyhydroxy fatty acid amide, low levels of undesired impurities such as fatty acid esters and cyclic amides, and which is molten typically above about 80° C., can be made by this process.

Nonionic fatty acid amide surfactant

Fatty acid amide surfactants or alkoxylated fatty acid amides can also be comprised by the composition herein. They include those having the formula: R⁶CON(R⁷)(R⁸) wherein R⁶ is an alkyl group containing from 7 to 21, preferably from 9 to 17 carbon or even 11 to 13 carbon atoms and R⁷ and R⁸ are each individually selected from the group consisting of hydrogen, C₁-C₄ alkyl, C₁-C₄ hydroxyalkyl, and —(C₂H₄O)ₓH, where x is in the range of from 1 to 11, preferably 1 to 7, more preferably form 1-5, whereby it may be preferred that R⁷ is different to R⁸, one having x being 1 or 2, one having x being from 3 to 11 or preferably 5.

Nonionic alkyl esters of fatty acid surfactant

Alkyl esters of fatty acids can also be comprised by the composition herein. They include those having the formula: R⁹COO(R¹⁰) wherein R⁹ is an alkyl group containing from 7 to 21, preferably from 9 to 17 carbon or even 11 to 13 carbon atoms and R¹⁰ is a C₁-C₄ alkyl, C₁-C₄ hydroxyalkyl, or —(C₂H₄O)ₓH, where x is in the range of from 1 to 11, preferably 1 to 7, more preferably form 1-5, whereby it may be preferred that R¹⁰ is a methyl or ethyl group.

Nonionic alkylpolysaccharide surfactant

Alkylpolysaccharides can also be comprised by the composition herein, such as those disclosed in U.S. Pat. No. 4,565,647, Llenado, issued Jan. 21, 1986, having a hydrophobic group containing from 6 to 30 carbon atoms and a polysaccharide, e.g., a polyglycoside, hydrophilic group containing from 1.3 to 10 saccharide units.

Preferred alkylpolyglycosides have the formula

R²O(CₙH₂ₙO)t(glycosyl)ₓ

wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl is preferably derived from glucose.

Polyethylene/propylene glycols

The composition herein may comprise polyethylene and/or propylene glycol, particularly those of molecular weight 1000-10000, more particularly 2000 to 8000 and most preferably about 4000.

Anionic Surfactant

The composition herein, preferably comprises one or more anionic surfactants. Any anionic surfactant useful for detersive purposes is suitable. Examples include salts (including, for example, sodium, potassium, ammonium, and substituted ammonium salts such as mono-, di- and triethanolamine salts) of the anionic sulphate, sulphonate, carboxylate and sarcosinate surfactants. Anionic sulphate surfactants are preferred.

Other anionic surfactants include the isethionates such as the acyl isethionates, N-acyl taurates, fatty acid amides of methyl tauride, alkyl succinates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), N-acyl sarcosinates. Resin acids and hydrogenated resin acids are also suitable, such as rosin, hydrogenated rosin, and resin acids and hydrogenated resin acids present in or derived from tallow oil.

Anionic sulphate surfactant

Anionic sulphate surfactants suitable for use herein include the linear and branched primary and secondary alkyl sulphates, alkyl ethoxysulphates, fatty oleoyl glycerol sulphates, alkyl phenol ethylene oxide ether sulphates, the C₅-C₁₇ acyl-N—(C₁-C₄ alkyl) and —N—(C₁-C₂ hydroxyalkyl) glucamine sulphates, and sulphates of alkylpolysaccharides such as the sulphates of alkylpolyglucoside (the nonionic non-sulphated compounds being described herein).

Alkyl sulphate surfactants are preferably selected from the linear and branched primary C₉-C₂₂ alkyl sulphates, more preferably the C₁₁-C₁₅ branched chain alkyl sulphates and the C₁₂-C₁₄ linear chain alkyl sulphates.

Alkyl ethoxysulfate surfactants are preferably selected from the group consisting of the C₁₀-C₁₈ alkyl sulphates which have been ethoxylated with from 0.5 to 50 moles of ethylene oxide per molecule. More preferably, the alkyl ethoxysulfate surfactant is a C₁₁-C₁₈, most preferably C₁₁-C₁₅ alkyl sulphate which has been ethoxylated with from 0.5 to 7, preferably from 1 to 5, moles of ethylene oxide per molecule.

Anionic sulphonate surfactant

Anionic sulphonate surfactants suitable for use herein include the salts of C₅-C₂₀ linear or branched alkylbenzene sulphonates, alkyl ester sulphonates, in particular methyl ester sulphonates, C₆-C₂₂ primary or secondary alkane sulphonates, C₆-C₂₄ olefin sulphonates, sulphonated polycarboxylic acids, alkyl glycerol sulphonates, fatty acyl glycerol sulphonates, fatty oleyl glycerol sulphonates, and any mixtures thereof.

Anionic carboxylate surfactant

Suitable anionic carboxylate surfactants include the alkyl ethoxy carboxylates, the alkyl polyethoxy polycarboxylate surfactants and the soaps (‘alkyl carboxyls’), especially certain secondary soaps as described herein.

Suitable alkyl ethoxy carboxylates include those with the formula RO(CH₂CH₂O)ₓCH₂COO⁻M⁺ wherein R is a C₆ to C₁₈ alkyl group, x ranges from O to 10, and the ethoxylate distribution is such that, on a weight basis, the amount of material where x is 0 is less than 20% and M is a cation. Suitable alkyl polyethoxy polycarboxylate surfactants include those having the formula RO—(CHR₁—CHR₂—O)_{X}—R₃ wherein R is a C₆ to C₁₈ alkyl group, x is from 1 to 25, R₁ and R₂ are selected from the group consisting of hydrogen, methyl acid radical, succinic acid radical, hydroxysuccinic acid radical, and mixtures thereof, and R₃ is selected from the group consisting of hydrogen, substituted or unsubstituted hydrocarbon having between 1 and 8 carbon atoms, and mixtures thereof.

Suitable soap surfactants include the secondary soap surfactants which contain a carboxyl unit connected to a secondary carbon. Preferred secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressers.

Alkali Metal Sarcosinate Surfactant

Other suitable anionic surfactants are the alkali metal sarcosinates of formula R—CON(R¹)CH₂COOM, wherein R is a C₅-C₁₇ linear or branched alkyl or alkenyl group, R¹ is a C₁-C₄ alkyl group and M is an alkali metal ion. Preferred examples are the myristyl and oleoyl methyl sarcosinates in the form of their sodium salts.

Cationic Surfactant

Another preferred surfactant is a cationic surfactant, which may preferably be present at a level of from 0.1% to 60% by weight of the composition herein, more preferably from 0.4% to 20%, most preferably from 0.5% to 5% by weight of the composition herein.

When present, the ratio of the anionic surfactant to the cationic surfactant is preferably from 35:1 to 1:3, more preferably from 15:1 to 1:1. most preferably from 10:1 to 1:1.

Preferably the cationic surfactant is selected from the group consisting of cationic ester surfactants, cationic mono-alkoxylated amine surfactants, cationic bis-alkoxylated amine surfactants and mixtures thereof.

Cationic mono-alkoxylated amine surfactants

Preferred cationic mono-alkoxylated amine surfactant for use herein, has the general formula:

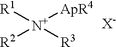

wherein R¹ is an alkyl or alkenyl moiety containing from about 6 to about 18 carbon atoms, preferably 6 to about 16 carbon atoms, most preferably from about 6 to about 11 carbon atoms; R² and R³ are each independently alkyl groups containing from one to about three carbon atoms, preferably methyl; R⁴ is selected from hydrogen (preferred), methyl and ethyl, X⁻ is an anion such as chloride, bromide, methylsulphate, sulphate, or the like, to provide electrical neutrality; A is selected from C₁-C₄ alkoxy, especially ethoxy (i.e., —CH₂CH₂O—), propoxy, butoxy and mixtures thereof; and p is from 1 to about 30, preferably 1 to about 15, most preferably 1 to about 8.

Highly preferred cationic mono-alkoxylated amine surfactants for use herein are of the formula:

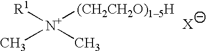

wherein R¹ is C₆-C₁₈ hydrocarbyl and mixtures thereof, preferably C₆-C₁₄, especially C₆-C₁₁ alkyl, preferably C₈ and C₁₀ alkyl, and X is any convenient anion to provide charge balance, preferably chloride or bromide.

As noted, compounds of the foregoing type include those wherein the ethoxy (CH₂CH₂O) units (EO) are replaced by butoxy, isopropoxy [CH(CH₃)CH₂O] and [CH₂CH(CH₃O] units (i-Pr) or n-propoxy units (Pr), or mixtures of EO and/or Pr and/or i-Pr units.

Cationic bis-alkoxylated amine surfactant

The cationic bis-alkoxylated amine surfactant for use herein, has the general formula:

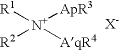

wherein R¹ is an alkyl or alkenyl moiety containing from about 6 to about 18 carbon atoms, preferably 6 to about 16 carbon atoms, more preferably 6 to about 11, most preferably from about 8 to about 10 carbon atoms; R² is an alkyl group containing from one to three carbon atoms, preferably methyl; R³ and R⁴ can vary independently and are selected from hydrogen (preferred), methyl and ethyl, X⁻ is an anion such as chloride, bromide, methylsulphate, sulphate, or the like, sufficient to provide electrical neutrality. A and A′ can vary independently and are each selected from C₁-C₄ alkoxy, especially ethoxy, (i.e., —CH₂CH₂O—), propoxy, butoxy and mixtures thereof; p is from 1 to about 30, preferably 1 to about 4 and q is from 1 to about 30, preferably 1 to about 4, and most preferably both p and q are 1.

Highly preferred cationic bis-alkoxylated amine surfactants for use herein are of the formula:

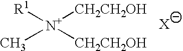

wherein R¹ is C₆-C₁₈ hydrocarbyl and mixtures thereof, preferably C₆, C₈, C₁₀, C₁₂, C₁₄ alkyl and mixtures thereof. X is any convenient anion to provide charge balance, preferably chloride. With reference to the general cationic bis-alkoxylated amine structure noted above, since in a preferred compound R¹ is derived from (coconut) C₁₂-C₁₄ alkyl fraction fatty acids, R² is methyl and ApR³ and A′qR⁴ are each monoethoxy.

Other cationic bis-alkoxylated amine surfactants useful herein include compounds of the formula:

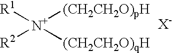

wherein R¹ is C₆-C₁₈ hydrocarbyl, preferably C₆-C₁₄ alkyl, independently p is 1 to about 3 and q is 1 to about 3, R² is C₁-C₃ alkyl, preferably methyl, and X is an anion, especially chloride or bromide.

Other compounds of the foregoing type include those wherein the ethoxy (CH₂CH₂O) units (EO) are replaced by butoxy (Bu) isopropoxy [CH(CH₃)CH₂O] and [CH₂CH(CH₃O] units (i-Pr) or n-propoxy units (Pr), or mixtures of EO and/or Pr and/or i-Pr units.

Amphoteric Surfactant

Suitable amphoteric surfactants for use herein include the amine oxide surfactants and the alkyl amphocarboxylic acids.

Suitable amine oxides include those compounds having the formula R³(OR⁴)ₓN⁰(R⁵)₂ wherein R³ is selected from an alkyl, hydroxyalkyl, acylamidopropoyl and alkyl phenyl group, or mixtures thereof, containing from 8 to 26 carbon atoms; R⁴ is an alkylene or hydroxyalkylene group containing from 2 to 3 carbon atoms, or mixtures thereof; x is from 0 to 5, preferably from 0 to 3; and each R⁵ is an alkyl or hydroxyalkyl group containing from 1 to 3, or a polyethylene oxide group containing from 1 to 3 ethylene oxide groups. Preferred are C₁₀-C₁₈ alkyl dimethylamine oxide, and C₁₀₋₁₈ acylamido alkyl dimethylamine oxide.

A suitable example of an alkyl aphodicarboxylic acid is Miranol(TM) C2M Conc. manufactured by Miranol, Inc., Dayton, N.J.

Zwitterionic Surfactant

Zwitterionic surfactants can also be comprised by the composition herein. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwitterionic surfactants for use herein.

Suitable betaines are those compounds having the formula R(R′)₂N⁺R²COO⁻ wherein R is a C₆-C₁₈ hydrocarbyl group, each R¹ is typically C₁-C₃ alkyl, and R² is a C₁-C₅ hydrocarbyl group. Preferred betaines are C₁₂₋₁₈ dimethyl-ammonio hexanoate and the C₁₀₋₁₈ acylamidopropane (or ethane) dimethyl (or diethyl) betaines. Complex betaine surfactants are also suitable for use herein.

Water-soluble Building Agent

The composition herein may comprises a water-soluble building agent, typically present at a level of from 0% to 36% by weight, preferably from 1% to 35% by weight, more preferably from 10% to 35%, even more preferably from 12% to 30% by weight of the composition or particle. Preferably, the water-soluble builder compound is an alkali or earth alkali metal salt of phosphate present at the level described above.

Other typical water-soluble building agents include the water soluble monomeric polycarboxylates, or their acid forms, homo or copolymeric polycarboxylic acids or their salts in which the polycarboxylic acid comprises at least two carboxylic radicals separated from each other by not more that two carbon atoms, borates, phosphates, and mixtures of any of the foregoing.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivatives such as the carboxymethyloxysuccinates described in British Patent No. 1,379,241, lactoxysuccinates described in British Patent No. 1,389,732, and aminosuccinates described in Netherlands Application 7205873, and the oxypolycarboxylate materials such as 2-oxa-1,1,3-propane tricarboxylates described in British Patent No. 1,387,447.

Polycarboxylates containing four carboxy groups include oxydisuccinates disclosed in British Patent No. 1,261,829, 1,1,2,2-ethane tetracarboxylates, 1,1,3,3-propane tetracarboxylates and 1,1,2,3-propane tetracarboxylates. Polycarboxylates containing sulfo substituents include the sulfosuccinate derivatives disclosed in British Patent Nos. 1,398,421 and 1,398,422 and in U.S. Pat. No. 3,936,448, and the sulphonated pyrolysed citrates described in British Patent No. 1,439,000. Preferred polycarboxylates are hydroxycarboxylates containing up to three carboxy groups per molecule, more particularly citrates.

Suitable examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation ranges from about 6 to 21, and salts of phytic acid.

Water Insoluble Building Agent

The composition herein preferably comprises a water-insoluble building agent. Examples of water insoluble builders include the sodium aluminosilicates.

Suitable aluminosilicate zeolites have the unit cell formula Na_{z}[(AlO₂)_{z}(SiO₂)y].xH₂O wherein z and y are at least 6; the molar ratio of z to y is from 1.0 to 0.5 and x is at least 5, preferably from 7.5 to 276, more preferably from 10 to 264. The aluminosilicate material are in hydrated form and are preferably crystalline, containing from 10% to 28%, more preferably from 18% to 22% water in bound form.

The aluminosilicate zeolites can be naturally occurring materials, but are preferably synthetically derived. Synthetic crystalline aluminosilicate ion exchange materials are available under the designations Zeolite A, Zeolite B, Zeolite P, Zeolite X, Zeolite HS and mixtures thereof. Zeolite A has the formula:

Na₁₂[AlO₂)₁₂(SiO₂)₁₂].xH₂O

wherein x is from 20 to 30, especially 27. Zeolite X has the formula Na₈₆[(AlO₂)₈₆(SiO₂)₁₀₆].276H₂O.

Preferred crystalline layered silicates for use herein have the general formula:

NaMSiₓO₂ₓ₊₁.yH₂O

wherein M is sodium or hydrogen, x is a number from 1.9 to 4 and y is a number from 0 to 20. Crystalline layered sodium silicates of this type are disclosed in EP-A-0164514 and methods for their preparation are disclosed in DE-A-3417649 and DE-A-3742043. Herein, x in the general formula above preferably has a value of 2, 3 or 4 and is preferably 2. The most preferred material is δ-Na₂Si₂0₅, available from Hoechst AG as NaSKS-6.

Peroxide Source

Another preferred ingredient is a perhydrate bleach, such as salts of percarbonates, particularly the sodium salts, and/or organic peroxyacid bleach precursor. It has been found that when the pouch or compartment is formed from a material with free hydroxy groups, such as PVA, the preferred bleaching agent comprises a percarbonate salt and is preferably free form any perborate salts or borate salts. It has been found that borates and perborates interact with these hydroxy-containing materials and reduce the dissolution of the materials and also result in reduced performance.

Inorganic perhydrate salts are a preferred source of peroxide. Preferably these salts are present at a level of from 0.01% to 50% by weight, more preferably of from 0.5% to 30% by weight of the composition or component.

Examples of inorganic perhydrate salts include percarbonate, perphosphate, persulfate and persilicate salts. The inorganic perhydrate salts are normally the alkali metal salts. The inorganic perhydrate salt may be included as the crystalline solid without additional protection. For certain perhydrate salts however, the preferred executions of such granular compositions utilise a coated form of the material which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

Alkali metal percarbonates, particularly sodium percarbonate are preferred perhydrates herein. Sodium percarbonate is an addition compound having a formula corresponding to 2Na₂CO₃.3H₂O₂, and is available commercially as a crystalline solid.

Potassium peroxymonopersulfate is another inorganic perhydrate salt of use in the compositions herein.

Bleach Activator

The composition herein preferably comprises a bleach activator, preferably comprising an organic peroxyacid bleach precursor. It may be preferred that the composition comprises at least two peroxy acid bleach precursors, preferably at least one hydrophobic peroxyacid bleach precursor and at least one hydrophilic peroxy acid bleach precursor, as defined herein. The production of the organic peroxyacid occurs then by an in situ reaction of the precursor with a source of hydrogen peroxide.

The bleach activator may alternatively, or in addition comprise a preformed peroxy acid bleach.

Preferably, at least one of the bleach activators, preferably a peroxy acid bleach precursor having an average particle size, by weight, of from 600 microns to 1400 microns, preferably from 700 microns to 1100 microns is present in the composition herein.

Hereby, it may be preferred that at least 80%, preferably at least 90% or even at least 95% or even substantially 100% of the component or components comprising the bleach activator have a particle size of from 300 microns to 1700 microns, preferably from 425 microns to 1400 microns.

The hydrophobic peroxy acid bleach precursor preferably comprises a compound having a oxy-benzene sulphonate group, preferably NOBS, DOBS, LOBS and/or NACA-OBS, as described herein.

The hydrophilic peroxy acid bleach precursor preferably comprises TAED, as described herein.

Organic Peroxyacid Bleaching System

The composition herein preferably comprises an organic peroxyacid precursor. The production of the organic peroxyacid may occur by an in situ reaction of such a precursor with the percarbonate source. In an alternative preferred execution a pre-formed organic peroxyacid is incorporated directly into the composition.

Peroxyacid Bleach Precursor

Peroxyacid bleach precursors are compounds which react with hydrogen peroxide in a perhydrolysis reaction to produce a peroxyacid. Generally peroxyacid bleach precursors may be represented as:

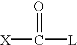

where L is a leaving group and X is essentially any functionality, such that on perhydrolysis the structure of the peroxyacid produced is:

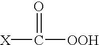

Suitable peroxyacid bleach precursor compounds typically contain one or more N— or O-acyl groups, which precursors can be selected from a wide range of classes. Suitable classes include anhydrides, esters, imides, lactams and acylated derivatives of imidazoles and oximes. Examples of useful materials within these classes are disclosed in GB-A-1586789. Suitable esters are disclosed in GB-A-836988, 864798, 1147871, 2143231 and EP-A-0170386.

Leaving Groups

The leaving group, hereinafter L group, must be sufficiently reactive for the perhydrolysis reaction to occur within the optimum time frame (e.g., a wash cycle). However, if L is too reactive, this activator will be difficult to stabilise for use herein.

Preferred L groups are selected from the group consisting of:

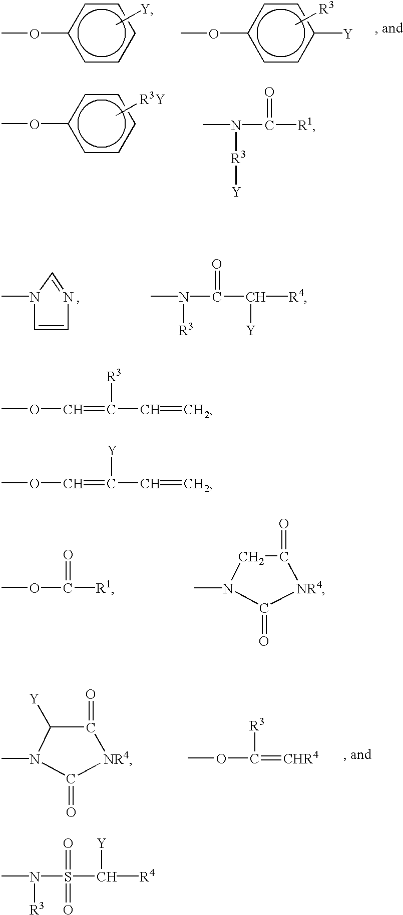

and mixtures thereof, wherein R¹ is an alkyl, aryl, or alkaryl group containing from 1 to 14 carbon atoms, R³ is an alkyl chain containing from 1 to 8 carbon atoms, R⁴ is H or R³, and Y is H or a solubilizing group. Any of R¹, R³ and R⁴ may be substituted by essentially any functional group including, for example alkyl, hydroxy, alkoxy, halogen, amine, nitrosyl, amide and ammonium or alkyl ammonium groups.

The preferred solubilizing groups are —SO₃⁻M⁺, —CO₂⁻M⁺, —SO₄⁻M⁺, —N⁺(R³)₄X⁻ and O<--N(R³)₃ and most preferably —SO₃⁻M⁺ and —CO₂⁻M⁺ wherein R³ is an alkyl chain containing from 1 to 4 carbon atoms, M is a cation which provides solubility to the bleach activator and X is an anion which provides solubility to the bleach activator. Preferably, M is an alkali metal, ammonium or substituted ammonium cation, with sodium and potassium being most preferred, and X is a halide, hydroxide, methylsulphate or acetate anion.

Amide Substituted Alkyl Peroxyacid Precursors

Amide substituted alkyl peroxyacid precursor compounds are suitable herein, including those of the following general formulae:

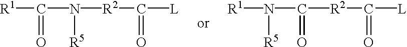

wherein R¹ is an alkyl group with from 1 to 14 carbon atoms, R² is an alkylene group containing from 1 to 14 carbon atoms, and R⁵ is H or an alkyl group containing 1 to 10 carbon atoms and L can be essentially any leaving group. Amide substituted bleach activator compounds of this type are described in EP-A-0170386.

Pre-formed Organic Peroxyacid

The organic peroxyacid bleaching system may contain a pre-formed organic peroxyacid.

A preferred class of organic peroxyacid compounds are the amide substituted compounds of the following general formulae:

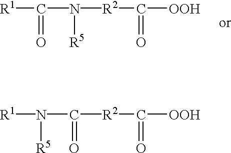

wherein R¹ is an alkyl, aryl or alkaryl group with from 1 to 14 carbon atoms, R² is an alkylene, arylene, and alkarylene group containing from 1 to 14 carbon atoms, and R⁵ is H or an alkyl, aryl, or alkaryl group containing 1 to 10 carbon atoms. Amide substituted organic peroxyacid compounds of this type are described in EP-A-0170386.

Other organic peroxyacids include diacyl and tetraacylperoxides, especially diperoxydodecanedioc acid, diperoxytetradecanedioc acid and diperoxyhexadecanedioc acid. Mono- and diperazelaic acid, mono- and diperbrassylic acid and N-phthaloylaminoperoxicaproic acid are also suitable herein.

Enzyme

Another preferred optional ingredient useful in the composition herein, is one or more additional enzymes.

Preferred additional enzymatic materials include the commercially available lipases, cutinases, amylases, neutral and alkaline proteases, esterases, cellulases, pectinases, lactases and peroxidases conventionally incorporated into compositions. Suitable enzymes are discussed in U.S. Pat. Nos. 3,519,570 and 3,533,139.

Preferred commercially available protease enzymes include those sold under the tradenames Alcalase, Savinase, Primase, Durazym, and Esperase by Novo Industries A/S (Denmark), those sold under the tradename Maxatase, Maxacal and Maxapem by Gist-Brocades, those sold by Genencor International, and those sold under the tradename Opticlean and Optimase by Solvay Enzymes. Protease enzyme may be incorporated into the composition herein at a level of from 0.0001% to 4% active enzyme by weight of the composition.

Preferred amylases include, for example, α-amylases obtained from a special strain of B licheniformis, described in more detail in GB-1,269,839 (Novo). Preferred commercially available amylases include for example, those sold under the tradename Rapidase by Gist-Brocades, and those sold under the tradename Termamyl and BAN by Novo Industries A/S. Amylase enzyme may be incorporated into the composition herein at a level of from 0.0001% to 2% active enzyme by weight of the composition.

Lipolytic enzyme may be present at levels of active lipolytic enzyme of from 0.0001% to 10% by weight of the particle, preferably 0.001% to 3% by weight of the composition, most preferably from 0.001% to 0.5% by weight of the compositions.

The lipase may be fungal or bacterial in origin being obtained, for example, from a lipase producing strain of Humicola sp., Thermomyces sp. or Pseudomonas sp. including Pseudomonas pseudoalcaligenes or Pseudomas fluorescens. Lipase from chemically or genetically modified mutants of these strains are also useful herein. A preferred lipase is derived from Pseudomonas pseudoalcaligenes, which is described in Granted European Patent, EP-B-0218272.

Another preferred lipase herein is obtained by cloning the gene from Humicola lanuginosa and expressing the gene in Aspergillus oryza, as host, as described in European Patent Application, EP-A-0258 068, which is commercially available from Novo Industri A/S, Bagsvaerd, Denmark, under the trade name Lipolase. This lipase is also described in U.S. Pat. No. 4,810,414, Huge-Jensen et al, issued Mar. 7, 1989.

Suds Suppressing System

The composition may comprise a suds suppresser at a level less than 10%, preferably 0.001% to 10%, preferably from 0.01% to 8%, most preferably from 0.05% to 5%, by weight of the composition Preferably the suds suppresser is either a soap, paraffin, wax, or any combination thereof. If the suds suppresser is a suds suppressing silicone, then the detergent composition preferably comprises from 0.005% to 0.5% by weight a suds suppressing silicone.

Suitable suds suppressing systems for use herein may comprise essentially any known antifoam compound, including, for example silicone antifoam compounds and 2-alkyl alcanol antifoam compounds.

By antifoam compound it is meant herein any compound or mixtures of compounds which act such as to depress the foaming or sudsing produced by a solution of the composition herein, particularly in the presence of agitation of that solution.

Particularly preferred antifoam compounds for use herein are silicone antifoam compounds defined herein as any antifoam compound including a silicone component. Such silicone antifoam compounds also typically contain a silica component. The term “silicone” as used herein, and in general throughout the industry, encompasses a variety of relatively high molecular weight polymers containing siloxane units and hydrocarbyl group of various types. Preferred silicone antifoam compounds are the siloxanes, particularly the polydimethylsiloxanes having trimethylsilyl end blocking units. Preferably the composition herein comprises from 0.005% to 0.5% by weight suds suppressing silicone.

Other suitable antifoam compounds include the monocarboxylic fatty acids and soluble salts thereof. These materials are described in U.S. Pat. No. 2,954,347, issued Sep. 27, 1960 to Wayne St. John. The monocarboxylic fatty acids, and salts thereof, for use as suds suppresser typically have hydrocarbyl chains of 10 to 24 carbon atoms, preferably 12 to 18 carbon atoms. Suitable salts include the alkali metal salts such as sodium, potassium, and lithium salts, and ammonium and alkanolammonium salts.

Other suitable antifoam compounds include, for example, high molecular weight fatty esters (e.g. fatty acid triglycerides), fatty acid esters of monovalent alcohols, aliphatic C₁₈-C₄₀ ketones (e.g. stearone) N-alkylated amino triazines such as tri- to hexa-alkylmelamines or di- to tetra alkyldiamine chlortriazines formed as products of cyanuric chloride with two or three moles of a primary or secondary amine containing 1 to 24 carbon atoms, propylene oxide, bis stearic acid amide and monostearyl di-alkali metal (e.g. sodium, potassium, lithium) phosphates and phosphate esters.

A preferred suds suppressing system comprises:

(a) antifoam compound, preferably silicone antifoam compound, most preferably a silicone antifoam compound comprising in combination:

(i) polydimethyl siloxane, at a level of from 50% to 99%, preferably 75% to 95% by weight of the silicone antifoam compound; and

(ii) silica, at a level of from 1% to 50%, preferably 5% to 25% by weight of the antifoam compound;

wherein said silica/silicone antifoam compound is incorporated at a level of less than 5%, preferably 0.01% to 5%, more preferably 0.05% to 4%, even more preferably 0.1% to 3%, by weight;

(b) a dispersant compound, most preferably comprising a silicone glycol rake copolymer with a polyoxyalkylene content of 72-78% and an ethylene oxide to propylene oxide ratio of from 1:0.9 to 1:1.1, at a level of less than 5%, preferably 0.01% to 5%, more preferably 0.05% to 4%, even more preferably 0.1% to 3%, by weight; a particularly preferred silicone glycol rake copolymer of this type is DCO544, commercially available from DOW Corning under the tradename DCO544;

(c) an inert carrier fluid compound, most preferably comprising a C₁₆-C₁₈ ethoxylated alcohol with a degree of ethoxylation of from 5 to 50, preferably 8 to 15, at a level of less than 5%, preferably 0.01% to 5%, more preferably 0.05% to 4%, even more preferably 0.1% to 3%, by weight;

A highly preferred particulate suds suppressing system is described in EP-A-0210731 and comprises a silicone antifoam compound and an organic carrier material having a melting point in the range 50° C. to 85° C., wherein the organic carrier material comprises a monoester of glycerol and a fatty acid having a carbon chain containing from 12 to 20 carbon atoms. EP-A-0210721 discloses other preferred particulate suds suppressing systems wherein the organic carrier material is a fatty acid or alcohol having a carbon chain containing from 12 to 20 carbon atoms, or a mixture thereof, with a melting point of from 45° C. to 80° C.

Polymeric Dye Transfer Inhibiting Agents

The composition herein may also comprise from 0.01% to 10%, preferably from 0.05% to 0.5% by weight of polymeric dye transfer inhibiting agents. These polymeric dye transfer inhibiting agents are in addition to the polymeric material of the water-soluble film.

The polymeric dye transfer inhibiting agents are preferably selected from polyamine N-oxide polymers, copolymers of N-vinylpyrrolidone and N-vinylimidazole, polyvinylpyrrolidonepolymers or combinations thereof.

a) Polyamine N-oxide polymers

Polyamine N-oxide polymers suitable for use herein contain units having the following structure formula:

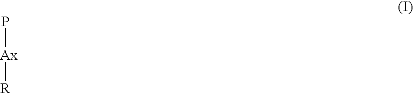

wherein P is a polymerisable unit, and

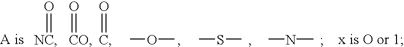

R are aliphatic, ethoxylated aliphatics, aromatic, heterocyclic or alicyclic groups or any combination thereof whereto the nitrogen of the N—O group can be attached or wherein the nitrogen of the N—O group is part of these groups.

The N—O group can be represented by the following general structures:

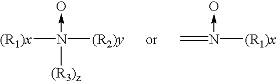

wherein R1, R2, and R3 are aliphatic groups, aromatic, heterocyclic or alicyclic groups or combinations thereof, x or/and y or/and z is 0 or 1 and wherein the nitrogen of the N—O group can be attached or wherein the nitrogen of the N—O group forms part of these groups. The N—O group can be part of the polymerisable unit (P) or can be attached to the polymeric backbone or a combination of both.

Suitable polyamine N-oxides wherein the N—O group forms part of the polymerisable unit comprise polyamine N-oxides wherein R is selected from aliphatic, aromatic, alicyclic or heterocyclic groups. One class of said polyamine N-oxides comprises the group of polyamine N-oxides wherein the nitrogen of the N—O group forms part of the R-group. Preferred polyamine N-oxides are those wherein R is a heterocyclic group such as pyrridine, pyrrole, imidazole, pyrrolidine, piperidine, quinoline, acridine and derivatives thereof.

Other suitable polyamine N-oxides are the polyamine oxides whereto the N—O group is attached to the polymerisable unit. A preferred class of these polyamine N-oxides comprises the polyamine N-oxides having the general formula (I) wherein R is an aromatic, heterocyclic or alicyclic groups wherein the nitrogen of the N—O functional group is part of said R group. Examples of these classes are polyamine oxides wherein R is a heterocyclic compound such as pyrridine, pyrrole, imidazole and derivatives thereof.

The polyamine N-oxides can be obtained in almost any degree of polymerisation. The degree of polymerisation is not critical provided the material has the desired water-solubility and dye-suspending power. Typically, the average molecular weight is within the range of 500 to 1000,000.

b) Copolymers of N-vinylpyrrolidone and N-vinylimidazole

Suitable herein are co-polymers of N-vinylimidazole and N-vinylpyrrolidone having an average molecular weight range of from 5,000 to 50,000. The preferred copolymers have a molar ratio of N-vinylimidazole to N-vinylpyrrolidone from 1 to 0.2.

c) Polyvinylpyrrolidone

The composition herein may also utilise polyvinylpyrrolidone (“PVP”) having an average molecular weight of from 2,500 to 400,000. Suitable polyvinylpyrrolidones are commercially available from ISP Corporation, New York, NY and Montreal, Canada under the product names PVP K-15 (viscosity molecular weight of 10,000), PVP K-30 (average molecular weight of 40,000), PVP K-60 (average molecular weight of 160,000), and PVP K-90 (average molecular weight of 360,000). PVP K-15 is also available from ISP Corporation. Other suitable polyvinylpyrrolidones which are commercially available from BASF Co-operation include Sokalan HP 165 and Sokalan HP 12.

d) Polyvinyloxazolidone

The composition herein may also utilise polyvinyloxazolidones as polymeric dye transfer inhibiting agents. Said polyvinyloxazolidones have an average molecular weight of from 2,500 to 400,000.

e) Polyvinylimidazole

The composition herein may also utilise polyvinylimidazole as polymeric dye transfer inhibiting agent. Said polyvinylimidazoles preferably have an average molecular weight of from 2,500 to 400,000.

Optical Brightener

The composition herein may also optionally comprise from 0.005% to 5% by weight of certain types of hydrophilic optical brighteners.

Hydrophilic optical brighteners useful herein include those having the structural formula:

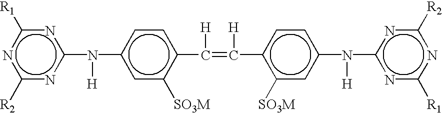

wherein R₁ is selected from anilino, N-2-bis-hydroxyethyl and NH-2-hydroxyethyl; R₂ is selected from N-2-bis-hydroxyethyl, N-2-hydroxyethyl-N-methylamino, morphilino, chloro and amino; and M is a salt-forming cation such as sodium or potassium.

When in the above formula, R₁ is anilino, R₂ is N-2-bis-hydroxyethyl and M is a cation such as sodium, the brightener is 4,4′,-bis[(4-anilino-6-(N-2-bis-hydroxyethyl)-s-triazine-2-yl)amino]-2,2′-stilbenedisulfonic acid and disodium salt. This particular brightener species is commercially marketed under the tradename Tinopal-UNPA-GX by Ciba-Geigy Corporation. Tinopal-UNPA-GX is the preferred hydrophilic optical brightener useful in the compositions herein.

When in the above formula, R₁ is anilino, R₂ is N-2-hydroxyethyl-N-2-methylamino and M is a cation such as sodium, the brightener is 4,4′-bis[(4-anilino-6-(N-2-hydroxyethyl-N-methylamino)-s-triazine-2-yl)amino]2,2′-stilbenedisulfonic acid disodium salt. This particular brightener species is commercially marketed under the tradename Tinopal 5BM-GX by Ciba-Geigy Corporation.

When in the above formula, R₁ is anilino, R₂ is morphilino and M is a cation such as sodium, the brightener is 4,4′-bis[(4-anilino-6-morphilino-s-triazine-2-yl)amino]2,2′-stilbenedisulfonic acid, sodium salt. This particular brightener species is commercially marketed under the tradename Tinopal AMS-GX by Ciba Geigy Corporation.

Cationic Fabric Softening Agents

Cationic fabric softening agents are preferably present in the composition herein. Suitable cationic fabric softening agents include the water insoluble tertiary amines or dilong chain amide materials as disclosed in GB-A-1 514 276 and EP-B-0 011 340. Preferably, these water-insoluble tertiary amines or dilong chain amide materials are comprised by the solid component of the composition herein.

Cationic fabric softening agents are typically incorporated at total levels of from 0.5% to 15% by weight, normally from 1% to 5% by weight.

Other Optional Ingredients

Other optional ingredients suitable for inclusion in the composition herein include perfumes, colours and filler salts, with sodium sulphate being a preferred filler salt.

Laundry Washing Method

Preferably, the multi-compartment pouch dissolves or disintegrates in water to deliver the solid detergent ingredients and liquid detergent ingredients to the washing cycle. Typically, the multi-compartment pouch is added to the dispensing draw, or alternatively to the drum, of an automatic washing machine.

Preferably, the multi-compartment pouch comprises all of the detergent ingredients of the detergent composition used in the washing. Although it may be preferred that some detergent ingredients are not comprised by the multi-compartment pouch and are added to the washing cycle separately. In addition, one or more detergent compositions other than the detergent composition comprised by the multi-compartment pouch can be used during the laundering process, such that said detergent composition comprised by the multi-compartment pouch is used as a pre-treatment, main-treatment, post-treatment or a combination thereof during such a laundering process.

### EXAMPLES

### Abbreviations Used in Examples

In the detergent compositions, the abbreviated component identifications have the following meaning:

| Abbreviation | Description |
|---|---|
| Alkoxylated | Tallow alcohol ethylene oxide condensate of type tallow alcohol, |
| alcohol(1): | condensed with an average of 50 moles of ethylene oxide |
| Alkoxylated | Tallow alcohol ethylene oxide condensate of type tallow alcohol, |
| alcohol(2): | condensed with an average of 80 moles of ethylene oxide |
| APA: | C8-C1O amido propyl dimethyl amine |
| C46SAS: | Sodium C14-C16 secondary (2,3) alkyl sulfate |
| CFAA: | C12-C14 (coco) alkyl N-methyl glucamide |
| CxyAS: | Sodium C1x-C1y alkyl sulfate |
| CxyEz: | C1x-C1y predominantly linear primary alcohol condensed with an |
| | average of z moles of ethylene oxide |
| CxyEzS: | Sodium C1x-C1y alkyl sulfate condensed with z moles of ethylene oxide |
| LAS(1): | Sodium linear C11-13 alkyl benzene sulfonate |
| LAS(2): | Potassium linear or branched C11-13 alkyl benzene sulfonate |
| QAS(1): | R2.N + (CH3)2(C2H4OH) with R2 = C12 − C14 |
| QAS(2): | R2.N + (CH3)2(C2H4OH) with R2 = C8 − C11 |
| STS: | Sodium toluene sulphonate |
| TAS: | Sodium tallow alkyl sulfate |
| TFAA: | C16-C18 alkyl N-methyl glucamide |
| TPKFA: | C12-C14 topped whole cut fatty acids |
| Bicarbonate(1): | Anydrous sodium bicarbonate having 80% by volume of particles with a |
| | particle size from 15 microns to 40 microns, having a volume median |
| | particle size of 25 microns |
| Bicarbonate(2): | Anhydrous sodium bicarbonate having 80% by volume of particles with |
| | a particle size from 100 microns to 200 microns with a volume median |
| | particle size of 150 microns |
| Carbonate(1): | Anydrous sodium carbonate having 80% by volume of particles with a |
| | particle size from 50 microns to 150 microns with a volume median |
| | particle size of 100 microns |
| Carbonate(2): | Anydrous sodium carbonate having 80% by volume of particles with a |
| | particle size from 35 microns to 75 microns, having a volume median |
| | particle size of 55 microns |
| Citrate: | Tri-sodium citrate dihydrate of activity 86.4% with a particle size |
| | distribution between 425 μm and 850 μm |
| Silicate: | Amorphous sodium silicate (SiO2:Na2O = 2.0:1) |
| Sulfate: | Anhydrous sodium sulfate |
| Citric acid(1): | Anhydrous citric acid, 80% having a particle size of from 40 microns to |
| | 70 microns, and having a volume median particle size of 55 microns |
| Citric acid(2): | Anhydrous or monohydrate citric acid, 80% having a particle size of |
| | from 15 microns to 40 microns, having a volume average particle size of |
| | 25 microns |
| Maleic acid: | Anhydrous maleic acid, 80% having a particle size of from 5 microns to |
| | 30 microns, having a volume median particle size of 15 microns |
| Malic acid: | Anhydrous malic acid, 80% having a particle size of from 50 microns to |
| | 100 microns, having a volume median particle size of 75 microns |
| NaSKS-6: | Crystalline layered silicate of formula d-Na2Si2O5 |
| STPP: | Anhydrous sodium tripolyphosphate |
| Tartaric acid: | Anhydrous tartaric acid, 80% having a particle size of from 25 microns |
| | to 75 microns, having a volume median particle size of 50 microns |
| TSPP: | Tetrasodium pyrophosphate |
| Zeolite A: | Hydrated sodium aluminosilicate of formula |
| | Na12(A1O2SiO2)12.27H2O having a primary particle size in the range |
| | from 0.1 to 10 micrometers (weight expressed on an anhydrous basis) |
| DTPA: | Diethylene triamine pentaacetic acid |
| DTPMP: | Diethylene triamine penta (methylene phosphonate), marketed by |
| | Monsanto under the Tradename Dequest 2060 |
| EDDS: | Ethylenediamine-N,N′-disuccinic acid, (S,S) isomer in the form of its |
| | sodium salt. |
| HEDP: | 1,1-hydroxyethane diphosphonic acid |
| Mg sulfate: | Anhydrous magnesium sulfate |
| Percarbonate: | Particle containing sodium percarbonate of nominal formula |
| | 2Na₂CO₃.3H₂O₂. |
| NAC-OBS: | Particle comprising (6-nonamidocaproyl) oxybenzene sulfonate, the |
| | particles having a weight average particle size of from 825 microns to |
| | 875 microns |
| NOBS: | Particle comprising nonanoyloxybenzene sulfonate in the form of the |
| | sodium salt, the particles having a weight average particle size of 750 |
| | microns to 900 microns |
| Brightener(1): | Disodium 4,4′-bis(2-sulphostyryl)biphenyl |
| Brightener(2): | Disodium 4,4′-bis(4-anilino-6-morpholino-1.3.5-triazin-2-yl)amino) |
| | stilbene-2:2′-disulfonate |
| PVI: | Polyvinyl imidosole, with an average molecular weight of 20,000 |
| PVP: | Polyvinylpyrolidone polymer, with an average molecular weight of |
| | 60,000 |
| PVNO: | Polyvinylpyridine N-oxide polymer, with an average molecular weight of |
| | 50,000 |
| PVPVI: | Copolymer of polyvinylpyrolidone and vinylimidazole, with an average |
| | molecular weight of 20,000 |
| AA: | Sodium polyacrylate polymer of average molecular weight 4,500 |
| CMC: | Sodium carboxymethyl cellulose |
| Cellulose ether: | Methyl cellulose ether with a degree of polymerisation of 650 available |
| | from Shin Etsu Chemicals |
| MA/AA(1): | Copolymer of 1:4 maleic/acrylic acid, average molecular weight about |
| | 70,000 |
| MA/AA(2): | Copolymer of 4:6 maleic/acrylic acid, average molecular weight about |
| | 10,000 |
| PEGx: | Polyethylene glycol, with a molecular weight of x, where x = from 1000 |
| | to 10000 |
| PEO: | Polyethylene oxide with an average molecular weight of from 10000 to |
| | 60000 |
| PEI(1): | Polyethyleneimine with an average molecular weight of 1800 and an |
| | average ethoxylation degree of 7 ethyleneoxy residues per nitrogen |
| PEI(2): | propoxylated/ethoxylated polyethylene imine |
| SRP(1): | Anionically end capped poly esters |
| SRP(2): | Diethoxylated poly (1,2 propylene terephtalate) short block polymer |
| Alcalase: | Proteolytic enzyme, having 5.3% by weight of active enzyme, sold by |
| | NOVO Industries A/S |
| Amylase: | Amylolytic enzyme, having 1.6% by weight of active enzyme, sold by |
| | NOVO Industries A/S under the tradename Termamyl 120T |
| Cellulase: | Cellulytic enzyme, having 0.23% by weight of active enzyme, sold by |
| | NOVO Industries A/S under the tradename Carezyme |
| Endolase: | Endoglucanase enzyme, having 1.5% by weight of active enzyme, sold |
| | by NOVO Industries A/S |
| Lipase(1): | Lipolytic enzyme, having 2.0% by weight of active enzyme, sold by |
| | NOVO Industries A/S under the tradename Lipolase |
| Lipase(2): | Lipolytic enzyme, having 2.0% by weight of active enzyme, sold by |
| | NOVO Industries A/S under the tradename Lipolase Ultra |
| Protease(1): | Proteolytic enzyme, having 3.3% by weight of active enzyme, sold by |
| | NOVO Industries A/S under the tradename Savinase |
| Protease(2): | Proteolytic enzyme, having 4% by weight of active enzyme, as described |
| | in WO 95/10591, sold by Genencor Int. Inc. |
| Silicone antifoam: | Polydimethylsiloxane foam controller with siloxane-oxyalkylene |
| | copolymer as dispersing agent with a ratio of said foam controller to said |
| | dispersing agent of 10:1 to 100:1 |
| Soap: | Sodium linear alkyl carboxylate derived from an 80/20 mixture of tallow |
| | and coconut fatty acids |

### Example I

A sheet of water-soluble film (Chris-Craft M-8630 film) is placed over a cylindrical-shaped mould having round sides and bottom and a diameter of 45 mm and a depth of 28 mm. A 1 mm thick layer of rubber is present around the edges of the mould. The mould has some holes in the mould material to allow a vacuum to be applied.

A vacuum is applied to pull the film into the mould so that the film is flush with the inner surface of the mould. 20 g of solid detergent composition is poured into the mould so that the mould is filled between 95% to 100%.

Next, another sheet of water-soluble film (Chris-Craft M-8630 film) is placed over the top of the mould with the solid composition, and is sealed to the first layer of film by applying an annular piece of flat metal of an inner diameter of 46 mm and heating that metal under moderate pressure onto the ring of rubber at the edge of the mould to heat-seal the two pieces of film together. The metal ring is typically heated to a temperature of 140-146° C. and applied for up to 5 seconds.

### Example II

The following compositions are in accordance with the invention. Said compositions are enclosed within a pouch comprising a water-soluble film (Chris-Craft M-8630 film). The pouch was made by the process described in example I.

| | A | B | C | D | E | F | G | H | I |
|---|---|---|---|---|---|---|---|---|---|
| Alkoxylated compound(1) | 1 | 10 | | | | 2 | 20 | 10 | 8 |
| Alkoxylated compound(2) | | | 5 | 20 | 10 | 6 | | 0.1 | |
| APA | | | | 1 | | | | | |
| C28E3S | 5 | | | | | | | | 1 |
| C28E7 | | | 2 | | | | | | 7 |
| C45E2 | | 6 | | | 0.1 | | | | |
| C45E3 | 3 | | | | | | | 6 | |
| C45E7 | 4 | 1 | | | | | | | |
| C24AS | | | | 0.3 | | | | | 4 |
| CFAA | 0.5 | 2 | 3 | | | 15 | | 4 | |
| LAS(1) | 4 | | 8 | | 10 | | | 1 | |
| LAS(2) | | 1 | | | | | 20 | | 5 |
| QAS(1) | | 5 | | 1 | 15 | | | | |
| QAS(2) | | | 4 | | | 3 | | | |
| STS | | 3 | | | | | | 6 | |
| TAS | 1 | | | 15 | | 0.01 | | | 0.1 |
| TFAA | | | | | | | | | 4 |
| TPKFA | | 3 | | | | | | | |
| Bicarbonate(1) | 2 | | 7 | | 10 | | 6 | | |
| Bicarbonate(2) | | | 4 | | | 15 | | | 8 |
| Carbonate(1) | 9 | | | | | | | 10 | |
| Carbonate(2) | 1 | 10 | | 6 | | | 3 | | 1 |
| Citrate | | 0.3 | 1 | | 5 | | 2 | | |
| Silicate | 1 | | | 3 | | 0.1 | 0.2 | | |
| Sulfate | | | | | | | 1 | | 0.3 |
| Citric Acid(1) | | | | 10 | | | | | |
| Citric Acid(2) | | 2 | | | | | | 3 | |
| Maleic Acid | | | | 2 | | | | | |
| Malic Acid | | 1 | | | | | 4 | | |
| NaSKS-6 | | 15 | 10 | 8 | 4 | 4 | | 1 | |
| STPP | | 3 | | | | 10 | | | 15 |
| Tartaric Acid | | | | | | | 2 | | |
| TSPP | | | | 4 | | | | | |
| Zeolite A | 20 | | 2 | | 10 | 1 | | 15 | |
| DTPA | | 0.4 | | | 0.2 | | | 0.1 | |
| DTPMP | | | | | | 0.3 | | | |
| HEDP | 0.5 | | | 0.4 | | | | 0.2 | |
| Mg Sulfate | | 0.2 | 0.3 | | 0.1 | | 0.4 | | |
| Percarbonate | 1 | 8 | 12 | | | | | | |
| NAC-OBS | 0.1 | | | 2 | | | | | |
| NOBS | | 0.1 | | | | | | | |
| Brightener(1) | 0.1 | 0.03 | | | | | | | |
| Brightener(2) | 0.05 | | 0.1 | | | | | | |
| PVI | | | | | | 0.3 | | 1 | |
| PVP | | | | | | | 0.1 | | 1 |
| PVPNO | | | | | | | | 0.6 | |
| PVPVI | | | | | | 0.4 | | | 0.7 |
| AA | 1 | | 0.3 | | | | | | |
| CMC | | 0.4 | | | | 1 | | | |
| MA/AA(1) | 1 | | | | 1.2 | | | | 0.4 |
| MA/AA(2) | | | 0.8 | 0.1 | | | 1.4 | | |
| SRP(1) | 0.1 | 0.2 | | | | | | | |
| SRP(2) | 0.1 | | 0.2 | | | | | | |
| Alcalase | | 0.5 | | | | | | | 0.3 |
| Amylase | | | | | | | 0.1 | 0.6 | |
| Cellulase | | | | | | 0.5 | | | |
| Endolase | | 0.1 | | | 0.4 | | | | 0.6 |
| Lipase(1) | 0.2 | | | | | | 0.5 | | |
| Lipase(2) | | 0.5 | 0.6 | | | | 0.3 | | |
| Protease(1) | | | | 0.5 | | | | 0.1 | |
| Protease(2) | 0.3 | | | | 0.1 | | | | |
| Perfume | 0.1 | 0.2 | | 0.3 | 0.3 | 0.1 | 0.4 | 0.2 | |
| Silicone antifoam | 0.2 | 0.1 | | | | | | | 0.4 |
| Soap | | 0.2 | | | | | | | |
| Misc/minor | to | to | to | to | to | to | to | to | to 100% |
| | 100% | 100% | 100% | 100% | 100% | 100% | 100% | 100% | |

### Example III

The following detergent compositions are in accordance with the invention. Said detergent compositions are enclosed within a pouch comprising a water-soluble film (Chris-Craft M-8630 film). The pouch was made by the process described in example I.

| | J | K | L | M | N | O | P | Q | R |
|---|---|---|---|---|---|---|---|---|---|
| Alkoxylated compound(1) | | 9 | 16 | | 7 | 5 | 1 | 0.4 | 5 |
| Alkoxylated compound(2) | 8 | 1 | | 12 | | 3 | 7 | 9 | 0.9 |
| C45E2 | 3 | | | | | | | | |
| C45E7 | | 15 | | | | | | | |
| C24AS | | | | 12 | | | | | |
| LAS(1) | 7 | | | | | 15 | | | |
| LAS(2) | | 6 | | 5 | | | | | |
| QAS(1) | | | | | | | | 15 | |
| STS | | | | | | | 10 | | |
| TAS | 4 | | 2 | | 8 | | | | |
| TFAA | | | | | | | 10 | | |
| TPKFA | | | | | | | | | 10 |
| Bicarbonate(1) | | | 18 | | | 10 | | 4 | |
| Bicarbonate(2) | 2 | | | | 21 | | 10 | | 22 |
| Carbonate(1) | 16 | | 1 | | | | 12 | 8 | |
| Carbonate(2) | 3 | 26 | | 22 | | 2 | | 6 | |
| Citrate | | | | | | 5 | | | |
| Silicate | | | | | 4 | | | | |
| Sulfate | | | | | | | | | |
| Citric Acid(1) | | | 3 | | 1 | | | 1 | 2 |
| Citric Acid(2) | 4 | | | | | | | | |
| Malic Acid | | | | | | | | 2 | |
| NaSKS-6 | | 12 | | 8 | 12 | | 15 | | |
| STPP | | | 14 | | | | | | |
| Tartaric Acid | | | | 1 | | | | 4 | |
| TSPP | | 4 | | | 3 | | | | |
| Zeolite A | 15 | | | 6 | | 20 | | 10 | 12 |
| EDDS | 0.2 | 0.2 | 0.1 | 0.3 | 0.1 | | | | |
| HEDP | | | | | | 0.3 | 0.2 | | 0.1 |
| Mg Sulfate | 0.3 | 0.2 | 0.4 | 0.3 | 0.5 | 0.4 | 0.1 | | 0.4 |
| Percarbonate | | 12 | | | 4 | 5 | 3 | | 2 |
| NAC-OBS | 3 | 1.2 | | | | | | | |
| NOBS | | | 1 | 1.3 | 1 | | | 0.5 | |
| Brightener(1) | 0.05 | 0.06 | 0.03 | 0.01 | | | 0.02 | | |
| Brightener(2) | | | | 0.01 | 0.03 | | | | 0.03 |
| PVI | | | | | | | | 0.4 | |
| MA/AA(1) | 2.1 | 1.1 | 1 | 3 | | | | | |
| MA/AA(2) | | | | | 2.4 | 1 | 1.5 | 2.1 | 3.1 |
| PEGx | 0.5 | 2 | | | | | | | |
| PEO | | | 3 | | | | | | |
| PEI(1) | 0.5 | 0.1 | | | | | | | |
| SRP(1) | | 0.1 | | | | 0.5 | 0.6 | | |
| SRP(2) | 0.5 | | 0.7 | | | | | | |
| Alcalase | 0.15 | 0.12 | | | | | | | |
| Amylase | | | | | 0.6 | | | | |
| Cellulase | | | | | | | 0.5 | 0.4 | 0.7 |
| Endolase | | | 0.4 | 0.2 | | | | | |
| Lipase(1) | | | 0.1 | 0.3 | 0.25 | 0.12 | | | |
| Lipase(2) | | | | | | | 0.1 | 0.2 | 0.06 |
| Protease(1) | 0.1 | 0.3 | 0.17 | | | | | | |
| Protease(2) | 0.1 | | 0.16 | | | 0.4 | | | |
| Perfume | 0.2 | 0.3 | 0.3 | 0.4 | 0.2 | 0.1 | 0.5 | 0.3 | 0.2 |
| Silicone antifoam | | | | | | 0.3 | | 0.17 | 0.26 |
| Soap | | | | | | 0.1 | 0.4 | 0.1 | 0.05 |
| Misc/minor | to | to | to | to | to | to | to | to | to 100% |
| | 100% | 100% | 100% | 100% | 100% | 100% | 100% | 100% | |

What is claimed is:

1. A composition comprising an alkoxylated compound having an average alkoxylation degree of at least 50, wherein the detergent composition is enclosed by a pouch made from a water-soluble film.

2. A composition according to claim 1, whereby said water-soluble film comprises polyvinyl alcohol.

3. A composition according to claims 1 or 2, whereby said alkoxylated compound has an average alkoxylation degree of at least 80.

4. A composition according to any of claims 1-3, whereby said alkoxylated compound is an ethoxylated compound.

5. A composition according to any preceding claim, whereby said alkoxylated compound is an alcohol, an ester, an aldehyde, a ketone, or a combination thereof.

6. A composition according to any preceding claim, whereby said alkoxylated compound is a tallow ethoxylated alcohol having an average ethoxylation degree of at least 80.

7. A composition according to any preceding claim, whereby said water-soluble film is stretchable, said water-soluble film has a stretch degree from 40% to 500%.

8. A composition according to claim 7, whereby said water-soluble film has a non-uniform thickness, said water-soluble film has a variation in thickness of at least 10%, preferably of from 40% to 500%.

9. A process for preparing a composition according to any of claims 1-8 comprising the steps;
(a) contacting a composition comprising an alkoxylated compound having an average alkoxylation degree of at least 50 to a water-soluble film in such a way as to partially enclose said detergent composition by said water-soluble film to obtain a partially formed pouch; and
(b) optionally contacting said partially formed pouch with a second water-soluble film; and
(c) sealing said partially formed pouch to obtain a pouch.

10. Use of an alkoxylated compound having an average alkoxylation degree of at least 50, preferably at least 80, to improve the cleaning performance of a detergent composition in wash water comprising water-soluble film material, in particular polyvinyl alcohol.

11. Use of a tallow ethoxylated alcohol having an average ethoxylation degree of at least 80 to improve the cleaning performance of a detergent composition in wash water comprising water-soluble film material, in particular polyvinyl alcohol.
